(19) United States
(12) Patent Application Publication
(10) Pub. No.: US 2006/0217947 A1
(43) Pub. Date: Sep. 28, 2006

(54) Method for determining the physicochemical properties of a three-dimensional body

(76) Inventor: Cesar Castanon Fernandez, Oviedo (ES)

Correspondence Address: OSTROLENK FABER GERB & SOFFEN, 1180 AVENUE OF THE AMERICAS, NEW YORK, NY, 100368403, US

(21) Appl. No.: 10/549,395

(22) PCT Filed: Mar. 14, 2003
(86) PCT No.: PCT/ES03/00117

§ 371 Date: Sep. 14, 2005

(51) Int. Cl. G06G 7/48

(52) U.S. Cl. 703/10

(57) ABSTRACT

The method of the invention for determining the physico-chemical properties of a three-dimensional body comprises the following stages: a) Generating a database (BDS) that contains the data on the bores that define the situation and the physico-chemical properties of the three-dimensional body,
b) Defining the surface (T1) in the spatial centre of the three-dimensional body by triangulation,
c) Defining on T1 a cluster of points (NPS) generated with regular spacings in the two main directions of the three-dimensional body,
d) Generating, by creating linked triangles between the points of NPS, a new surface (T2), very similar to T1 but in the suitable format for interpolation and graphical representation, e) Calculating, by any interpolation method, the properties of the points of NPS from the bore database BDS,
f) Generating a new database (BDT2) using the triangles of the surface T2 that contains, for each triangle, the data of the coordinates of the vertices, the results of the interpolation of the vertices and the area of this triangle in space,
g) Generating reports with the desired information from the database BDT2 and
h) Generating three-dimensional graphical representations from the database BDT2.

### FIELD OF THE INVENTION

The invention relates to determining the physico-chemical properties of a three-dimensional body; specifically, the invention relates to a method for determining the physico-chemical properties of a three-dimensional body. More specifically, the invention relates to a method for determining the mineral resources or reserves of a mineral body or layer.

### BACKGROUND OF THE INVENTION

Several methods are known in the state of the art for determining the physico-chemical properties of three-dimensional bodies. Specifically, for determining the mineral resources or reserves of a mineral body or layer, this is, for calculating geological resources or mineral reserves in mineral bodies in the form of a layer. The most widely used methods are:

Sections method: using bores made in sections that cut the mineral body, calculations are made obtaining the grades in each section. Then the area of each section is calculated and multiplied by half the distance to the anterior and posterior sections to thereby obtain the volume. Although the advantage of this method is that it can be applied to all types of layers, even very folded ones, it has many disadvantages, such as that each time a calculation parameter is changed, as the cut-off grade, the process must be started all over again; that as a grade calculation is made in each section, an interpolation direction cannot be used; that the bores not in the sections of calculation must be projected to the nearest one, complicating the process and, finally, that the sections method is very difficult to computerise.

Polygons method: this method consists of projecting the centres of the intersections onto a plane and assigning to each intersection a polygon defined by the method of perpendicular or angular bisectors. Each polygon shall have the laws and powers or the intersection in the centre. Although this method is easy to apply and computerise, it has the following disadvantages: it cannot be used for folded layers; the calculation is not performed by interpolation of several bores, so that the grades obtained are over-optimistic; and it does not work in three dimensions.

Triangles method: this method consists of projecting the intersections of the mineral layer onto a plane and defining the triangles formed when joining the vertices by triangulation. Each triangle is given the power and grades of the median of the intersections in the vertices. As with the previous method, this method is easy to use and computerise but it cannot be used for folded layers nor in three dimensions.

Blocks method: this method consists of dividing the calculation area into blocks (parallelepipeds) and calculate the properties of each block interpolating with the intersections around it. This is the most widely used method, but its disadvantage is that for layer-shaped mineral bodies, as parallelepipeds are used, the geometric shape of the layer does not resemble the geometric shape of the blocks, and in thin layers it becomes even more complex.

Thus, there is a need in the state of the art for an alternative method for determining the physico-chemical properties of a three-dimensional body that can improve on the commonly-used methods.

The object of the present application is to provide an alternative method for determining the physico-chemical properties of a three-dimensional body, more specifically for determining the mineral resources or reserves of a mineral body or layer.

The present method, which fulfils the requirements of working in three dimensions and being fully computerisable, is based on the iterative use of the triangulation method on the extrapolation of data obtained by bores. Moreover, the method of the invention illustrates the following advantages over the methods known in the state of the art:
Any change of calculation parameter does not require a redefinition of the calculation units,
It defines calculation units in space, which can later be used to plan, draw and export to other programs,
It is possible to interpolate with any of the available methods, from the simplest method of assigning to each calculation unit the value of the nearest intersection, to applying the inverse of the distance or geostatistical methods.
It represents faithfully the power of the layer or mineral body, a fundamental information in thin layers.

### BRIEF DESCRIPTION OF THE FIGURES

FIG. 1 illustrates the drillings or bores made in a three-dimensional body or layer.

FIG. 2 illustrates the intersections resulting from the bore or drill segments that cut a mineral body or layer.

FIG. 3 shows a calculation unit, consisting of the part of the three-dimensional body or layer that has the same data (data 1, data 2) after the interpolation.

FIG. 4 illustrates the surface in space of the three-dimensional body or layer at its mid point defined by triangulation (T1), this is, a set of triangles linked in space that define a surface in the centre of the three-dimensional body or layer.

FIG. 5 shows a cluster of points (NPS) generated by regular spacings in the two main directions of the three-dimensional body or layer.

FIG. 6 shows the new surface T2 (as well as a detail of this surface) defined by triangulation of the points of the cluster NPS.

FIG. 7 shows the three-dimensional representation obtained by applying the method of the present invention.

FIG. 8 illustrates the layer T1 defined by triangulation of the data obtained from the bores and their interpolation from example 1.

FIG. 9 shows the cluster of points NPS and the surface T2 obtained by triangulation in example 1.

FIG. 10 illustrates the golden grade of the mineral layer of example 1.

Finally, FIG. 11 shows the three-dimensional view of the mineral layer of example 1.

### DETAILED DESCRIPTION OF THE INVENTION

To aid the comprehension of the present invention, the meaning of some of the concepts used in the present text is explained below:

Three-dimensional body: a spatial body that may be predominantly in two of the three dimensions. When the method is applied to calculate geological resources, it will be a mineral body or layer.

Bores: drillings made in bodies or layers to obtain samples for analysis and interpretation.

Intersection: segment of the bore that cuts a layer of three-dimensional body.

Interpolation: Calculation mode in which we define the data of a point of the layer or three-dimensional body using the information on the intersections surrounding it. It is possible to use the simplest method, in which the point is given the value of the nearest intersection, or the arithmetical mean of the intersections at a maximum distance, by an inverse power of the distance; or geostatistical interpolation methods, Kriging, etc. It is also possible to use intersection search ellipsoids giving preferred directions, as is conventional in geostatistics.

Calculation unit: part of the layer or three-dimensional body which for calculation purposes shall have the same Data1, Data2, etc. obtained from the interpolation.

In a first aspect, the invention provides a method for determining the physico-chemical properties of a three-dimensional body that involves:
a) Generating a database (BDS) that contains the data on the bores that define the situation and the physico-chemical properties of the three-dimensional body,
b) Defining the surface (T1) in the spatial centre of the three-dimensional body by triangulation,
c) Defining on T1 a cluster of points (NPS) generated with regular spacings in the two main directions of the three-dimensional body,
d) Generating, by creating linked triangles between the points of NPS, a new surface (T2), very similar to T1 but in the suitable format for interpolation and graphical representation,
e) Calculating, by any interpolation method, the properties of the points of NPS from the bore database BDS,
f) Generating a new database (BDT2) using the triangles of the surface T2 that contains, for each triangle, the data of the coordinates of the vertices, the results of the interpolation of the vertices and the area of this triangle in space,
g) Generating reports with the desired information from the database BDT2 and
h) Generating three-dimensional graphical representations from the database BDT2.

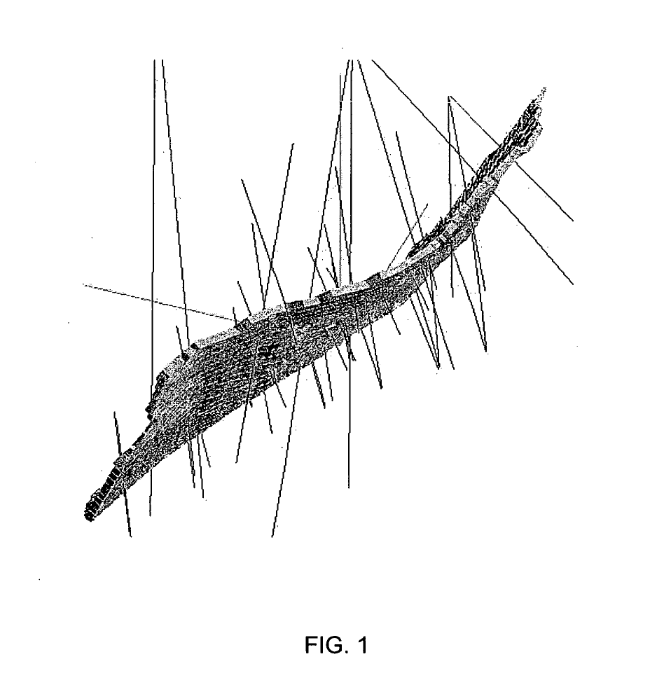

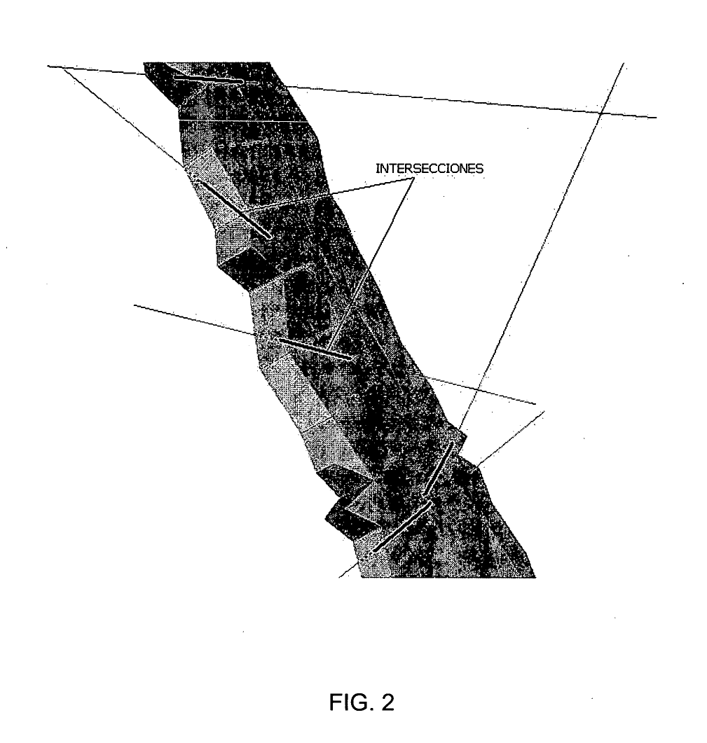

According to the method of the present invention, the database BDS is generated in stage a) from the information obtained in the intersections (see FIGS. 1 and 2) and comprises the following data:
Data n the (x, y, z) coordinates that define the position of each bore (s1, s2, etc.) in the three-dimensional body (intersection of the bores and the three-dimensional body), where the coordinates can either define a single point that determines the centre of the body or an interval determining the beginning and the end of the three-dimensional body,
Data on the properties of the three-dimensional body such as the data on the actual width of the three-dimensional body (real power), analysis data, geotechnical data, geological data, etc. (data 1, data 2, etc.) for each bore (s1, s2, etc.).

Then the stage b) is performed, in which the surface (T1) is generated in the spatial centre of the three-dimensional body by applying the triangulation method to the database BDS (see FIG. 4), specifically using:
The coordinates of the centre of the bores,
The three-dimensional interpretation of the known data of this body,
Prior knowledge of the typical shape of this type of body.

The triangulation method consists of forming linked triangles between the points that form the database. An algorithm is preferably used, such as the Delaunay algorithm.

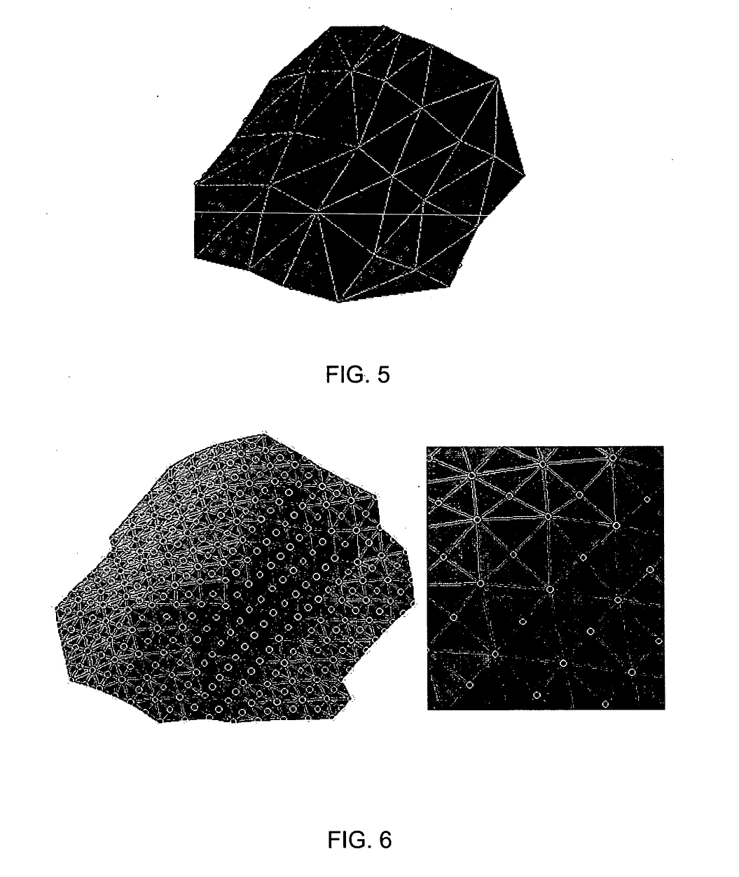

In the next stage, c), a cluster of points (NPS) is defined on the surface T1, generated by any algorithm based on regular spacings on the surface, this is, on the two main directions of the three-dimensional body (see FIG. 5). A possible algorithm can be as follows:
Generate the lines defining the intersection between the surface and equidistant parallel sections in each of the main planes,
Divide these lines into equal segments,
The set of vertices defined by the lines in each segment shall form a cluster of points equidistant in one direction to the separation between the sections and in the other direction in the size of the segments.

According to stage d), performing a triangulation on the points of the cluster of points NPS generates a new surface, T2, very similar to T1 but with the suitable format for interpolation and graphical representation (see FIG. 6).

Then, in stage e) of the procedure the properties of the points of NPS are calculated by any interpolation method, ranging from the simplest method of giving it the properties of the nearest bore, a power of the inverse of the distance or any statistical method, using the bore database BDS.

Then a new database is generated (BDT2) using the triangles of the previously generated surface T2 that contains, for each triangle, the data of the coordinates of the vertices, the results of the interpolation of the vertices, and the area of this triangle in space.

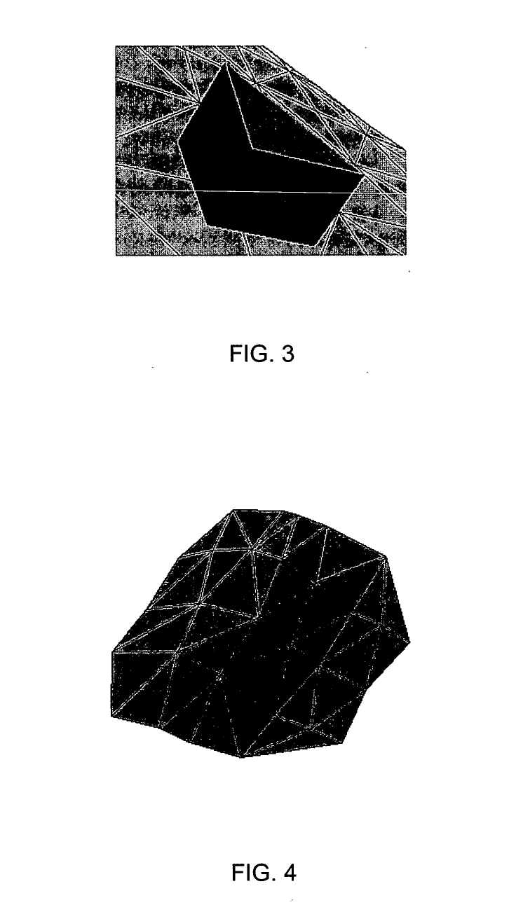

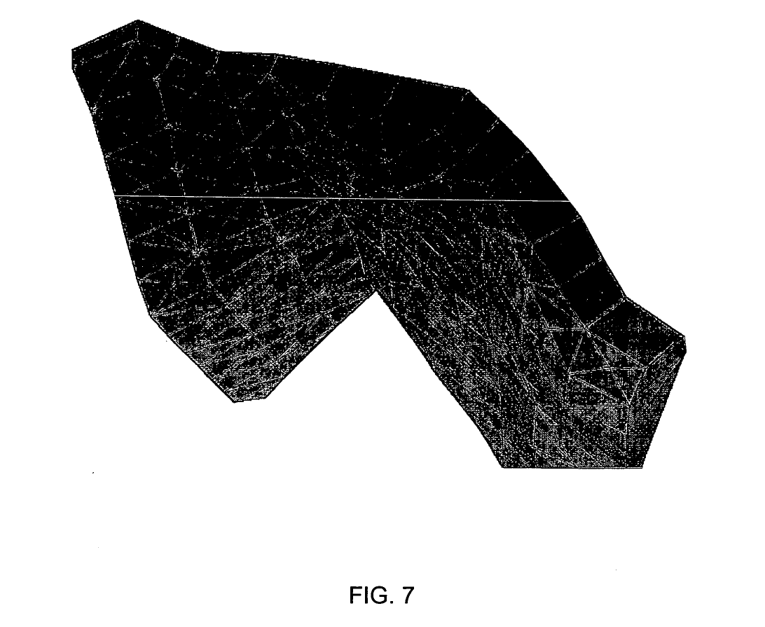

Finally, the database BDT2 allows generating reports or graphical representations of the layer or three-dimensional body (see FIG. 7). Graphical software can be used to obtain the graphical representations, keeping in mind the following (see FIG. 3):
Each triangle shall be the centre of a calculation unit,
Each triangle shall have in each vertex a segment that measures the real power at this point with the direction of the average of the perpendiculars to the planes formed by all the triangles sharing this vertex. In this way all triangles sharing a vertex also share this segment (edge) allowing all the calculation units to fit in perfectly in space,
The three aforementioned segments, together with the two triangles formed by joining their ends, define the volume of each calculation unit.

A second aspect of the invention consists of applying the previously described method to determine the resources or mineral reserves of a mineral body or layer. This method comprises the following stages:
a) Generating a database (BDS) that contains the data on the intersections of the bores defining the mineral body or layer, this database comprising:
   Data of the (x,y,z) coordinates defining the position of each bore (s1, s2, etc.) in the mineral body or layer (the intersection of the bores with the mineral body or layer), wherein the coordinates can either define a single point determining the centre of the body or an interval determining the beginning and the end of the three-dimensional body,
   Data on the properties of the mineral body or layer (data 1, data 2, etc.) for each bore (s1, s2, etc.).
b) Defining the surface in the spatial centre of the mineral body or layer (T1) by forming linked triangles between the median points of each bore position (s1, s2, etc.) or intersections; to do so the following steps shall be followed:
   Using the centres of the intersections of the bores with the mineral layer, the information on any outcrops of the layer and the geological interpretation regarding the spatial location of the layer, a set of points and lines are defined located on the central surface of the mineral body or layer,
   Using these points and lines, the surface they form is defined by triangulation, providing a set of linked triangles in the space,
   As many points and lines are added so that the surface generated by triangulation is a faithful representation of the centre of the mineral layer or body and it covers the entire area to be included in the study;
c) Defining on T1 a cluster of points (NPS) generated with regular spacings in the two main directions of the three-dimensional body, for which the following steps are followed:
   An algorithm is used to fill in the surface T1 with points that are more or less equidistant to one another,

The distance between the points is defined according to the calculation detail required so that its final three-dimensional representation agrees with the initial interpretation of the layer,

Depending on the algorithm used, the real distance between the points is not necessarily always the same;
d) Generating, by forming linked triangles between the points NPS, a new surface (T2) that will be very similar to T1 but has the suitable format for interpolation and graphical representation, for which a triangulation algorithm shall be used on this cluster of points,
e) Calculating, by any interpolation method, the properties of the points NPS from the bore database BDS,
   When interpolating, for each point of NPS the properties of the three-dimensional body at this point are calculated using the information on the intersections of the surrounding bores,
   The interpolation can be by the simplest method of giving it the properties of the nearest intersection, a power of the inverse of the distance, or geostatistical methods such as Kriging or others,
f) Generating a new database (BDT2), from the triangles of the surface T2, which contains, for each triangle, the data of the coordinates of the vertices, the results of the interpolation of the vertices and the area of this triangle in space,
g) Generating reports with the desired information using the database BDT2.
h) Generating a three-dimensional graphical representation from the database BDT2 by graphics software that allows a three-dimensional representation.

In the same manner as described for the general method, when generating the three-dimensional graphical representation from the database BDT2 the following shall be kept in mind:
Each triangle shall be the centre of a calculation unit,

Each triangle shall have in each vertex a segment that measures the real power at this point with the direction of the average of the perpendiculars to the planes formed by all the triangles sharing this vertex. In this way all triangles sharing a vertex also share this segment (edge) allowing all the calculation units to fit in perfectly in space,
The three aforementioned segments, together with the two triangles formed by joining their ends, define the volume of each calculation unit.

The following example is allows illustrating the invention.

### EXAMPLE 1

A calculation is performed of gold (Au), silver (Ag), copper (Cu) and Arsenic (As) reserves of a mineral layer, specifically of the gold grade of this mineral layer. To do so, the following database is generated (BDS; table 1) from the data of the intersections of the mineral layer bores whose reserves are being calculated.

TABLE 1
Bore intersections database (BDS)

| Bore | X1 | y1 | Z1 | X2 | Y2 | z2 | P_R | <Au> | <Ag> | <Cu> | <As> |
|---|---|---|---|---|---|---|---|---|---|---|---|
| C1 | 3410.56 | 4743.39 | 34.48 | 3408.74 | 4743.11 | 32.36 | 1.03 | 15157 | 9.8 | 8964 | 1710 |
| C2 | 3484.50 | 4752.75 | −3.93 | 3484.50 | 4752.75 | −4.97 | 0.62 | 2900 | 0.5 | 140 | 22000 |
| C14 | 3504.01 | 4705.67 | 62.66 | 3504.12 | 4704.50 | 61.46 | 1.59 | 50 | 0.2 | 210 | 100 |
| C48 | 3447.84 | 4717.71 | 72.27 | 3447.66 | 4717.53 | 72.03 | 0.31 | 112000 | 265.0 | 87000 | 1500 |
| C50 | 3360.35 | 4732.75 | 91.48 | 3359.18 | 4732.60 | 90.27 | 1.13 | 1400 | 3.3 | 1500 | 500 |
| C54 | 3424.93 | 4795.93 | −19.36 | 3424.92 | 4795.93 | −19.84 | 0.35 | 600 | 0.4 | 220 | 2500 |
| C56 | 3381.05 | 4789.08 | 4.58 | 3380.78 | 4789.04 | 3.67 | 0.67 | 3800 | 3.2 | 7200 | 2000 |
| C1006 | 3428.36 | 4735.83 | 46.56 | 3429.24 | 4736.23 | 46.3 | 0.35 | 6900 | 6.2 | 5800 | 5384 |
| C1008 | 3410.86 | 4731.38 | 58.20 | 3411.97 | 4732.12 | 58.1 | 0.77 | 2050 | 15.7 | 9200 | 2335 |
| C1009 | 3432.70 | 4717.43 | 69.83 | 3435.27 | 4719.15 | 68.18 | 1.22 | 6430 | 4.9 | 6793 | 158 |
| C1012 | 3399.93 | 4722.64 | 70.98 | 3399.21 | 4722.04 | 70.98 | 0.59 | 2050 | 0.5 | 570 | 1387 |
| C1028 | 3450.20 | 4729.57 | 43.21 | 3448.07 | 4728.15 | 43.21 | 1.62 | 8433 | 10.4 | 16579 | 1672 |
| C1030 | 3428.60 | 4743.34 | 42.44 | 3427.98 | 4742.89 | 42.44 | 0.65 | 2200 | 1.3 | 1800 | 2101 |
| C1033 | 3394.24 | 4748.73 | 43.12 | 3393.43 | 4748.12 | 43.15 | 0.73 | 1950 | 0.3 | 110 | 2725 |
| C1036 | 3381.13 | 4742.83 | 56.76 | 3381.90 | 4743.37 | 56.74 | 0.67 | 3900 | 17.4 | 5700 | 334 |
| C1038 | 3361.55 | 4761.40 | 49.45 | 3361.32 | 4761.26 | 49.22 | 0.31 | 5400 | 9.0 | 9200 | 240 |
| C1040 | 3350.95 | 4752.76 | 68.64 | 3350.35 | 4752.35 | 68.24 | 0.75 | 1400 | 3.4 | 850 | 35000 |
| C1041 | 3396.22 | 4723.10 | 74.37 | 3396.86 | 4723.58 | 75.07 | 0.98 | 800 | 0.1 | 0 | 3900 |
| C1042 | 3415.62 | 4703.39 | 91.20 | 3413.79 | 4701.84 | 88.97 | 3.03 | 9992 | 6.3 | 5433 | 15114 |
| C1043 | 3385.21 | 4716.70 | 99.86 | 3384.44 | 4716.24 | 99.11 | 1.06 | 1975 | 2.4 | 1200 | 253 |
| C1044 | 3399.21 | 4753.59 | 31.22 | 3398.36 | 4753.02 | 30.68 | 0.99 | 2575 | 1.8 | 1200 | 2552 |
| C1045 | 3379.32 | 4768.75 | 27.37 | 3378.21 | 4767.86 | 26.63 | 1.44 | 6001 | 1.3 | 1334 | 58372 |
| C1046 | 3422.80 | 4740.28 | 35.56 | 3422.20 | 4739.90 | 34.91 | 0.56 | 4400 | 3.7 | 2300 | 200 |
| C1048 | 3342.73 | 4775.78 | 33.40 | 3342.52 | 4775.66 | 32.77 | 0.50 | 2800 | 0.2 | 65 | 37000 |
| C1069 | 3363.54 | 4790.62 | 5.03 | 3359.31 | 4787.81 | 3.28 | 3.88 | 8317 | 1.1 | 230 | 9237 |
| C1085 | 3416.09 | 4767.54 | 10.32 | 3416.34 | 4767.71 | 10.5 | 0.31 | 10800 | 1.5 | 570 | 7100 |
| C1086 | 3419.46 | 4770.61 | 3.27 | 3420.04 | 4771.04 | 3.17 | 0.46 | 1400 | 1.2 | 880 | 1300 |
| C1089 | 3375.24 | 4738.38 | 69.34 | 3375.65 | 4738.66 | 69.99 | 0.71 | 4850 | 8.4 | 4000 | 4400 |
| C1091 | 3469.66 | 4744.69 | 10.87 | 3470.87 | 4745.64 | 11.43 | 1.32 | 1200 | 0.0 | 1 | 260 |
| C1092 | 3460.13 | 4737.64 | 28.63 | 3461.26 | 4738.52 | 30.53 | 1.98 | 7563 | 21.4 | 18584 | 1244 |
| C1094 | 3453.25 | 4699.67 | 87.66 | 3451.72 | 4698.62 | 85.83 | 1.79 | 8908 | 11.2 | 14172 | 7732 |
| C1095 | 3463.88 | 4706.83 | 66.07 | 3463.73 | 4706.72 | 65.37 | 0.46 | 8800 | 5.6 | 9700 | 1 |
| C1096 | 3491.66 | 4730.12 | 23.31 | 3491.67 | 4730.13 | 23.31 | 0.01 | 0 | 0.0 | 1 | 1 |
| C1097 | 3478.95 | 4719.08 | 43.68 | 3479.15 | 4719.27 | 44.57 | 0.69 | 3550 | 1.1 | 200 | 7600 |
| C1101 | 3479.22 | 4695.63 | 92.56 | 3479.34 | 4695.22 | 92.13 | 0.51 | 0 | 0.5 | 70 | 1 |
| C1102 | 3449.92 | 4756.86 | −0.02 | 3452.86 | 4758.67 | −0.2 | 1.47 | 4872 | 11.3 | 8561 | 596 |
| C1103 | 3435.55 | 4750.75 | 15.95 | 3437.39 | 4752.27 | 17.56 | 2.67 | 8184 | 7.7 | 7286 | 1003 |
| C1104 | 3349.80 | 4724.32 | 116.14 | 3350.52 | 4724.90 | 116.46 | 0.84 | 950 | 0.6 | 560 | 920 |
| INT103 | 3433.87 | 4710.28 | 71.03 | 3435.80 | 4712.07 | 71.05 | 1.56 | 4990 | 2.4 | 3418 | 455 |

where:
(x1,y1,z1) and (x2,y2,z2) are the initial and final coordinates of the intersection of the bore with the layer.
P_R is the real power of the layer in each intersection.
<Au>, <Ag>, <Cu> and <As> are the properties of the layer in each intersection, in this case they are analytical data of the elements Au, Ag, Cu and As.

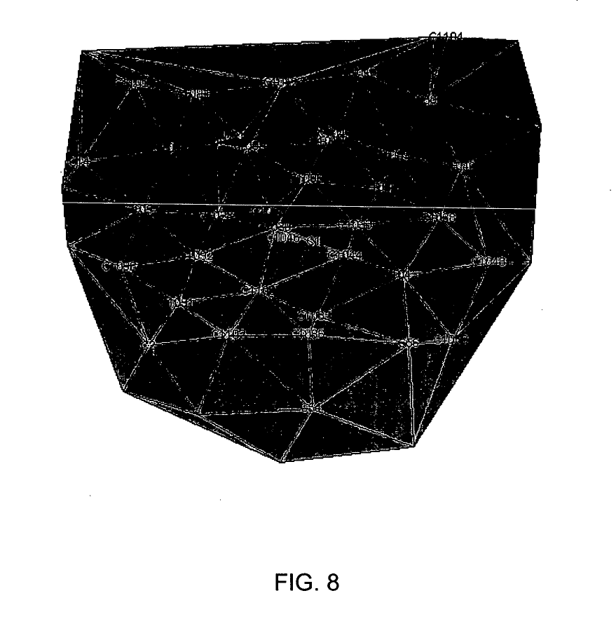

Based on the coordinates of the centres of the intersections and the geological interpretation, a surface (T1) is defined by triangulation that represents the centre of the layer (see FIG. 8).

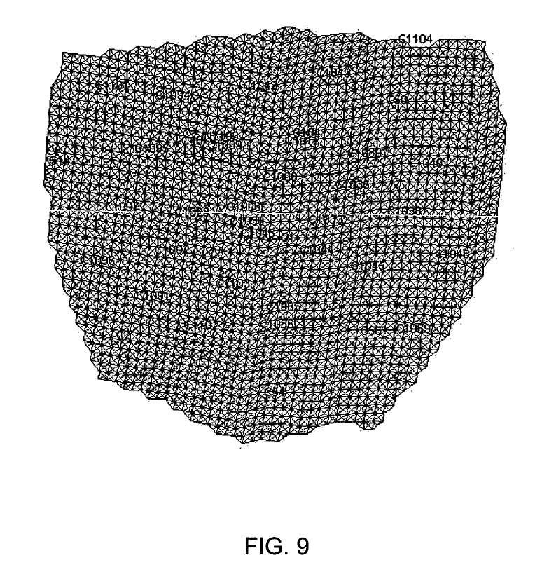

Then, the cluster of points (NPS) is defined on the anterior surface T1 followed by the triangulation T2 (see FIG. 9).

In this way, for each vertex we have its coordinates and the results of the interpolation, and for each triangle of T2 we have the information on the three vertices that define it, so that the triangle represented in the following table will be that formed by the vertices 30038000070, 30038500060 and 30039000060, where each vertex has real power (P_R) and <Au>, <Ag>, <Cu> and <As> values obtained from the interpolation of the intersections of the surrounding bores, which are also shown in the table.

In this case the interpolation has been made by the inverse cube of the distance and the distances (Dist. in the table) are the distances between the point and the centres of the intersections of the bores.
g=[gᵢ/(dᵢ)^{P}]/[1/(dᵢ)^{P}]
g=result of the interpolation.
gᵢ=data of intersection i.
d=distance from the centre of intersection i and the point being interpolated.

P=3

| NPSID | Dist | Bore | P_R | <Au> | <Ag> | <Cu> | <As> |
|---|---|---|---|---|---|---|---|
| 30038000070 | 23.9 | C1043 | 1.06 | 1,975 | 2.4 | 1,200 | 253 |
| 30038000070 | 26.9 | C1041 | 0.98 | 800 | 0.1 | 0 | 3,900 |
| 30038000070 | 30.1 | C1042 | 3.03 | 9,992 | 6.3 | 5,433 | 15,114 |
| 30038000070 | 32.4 | C1012 | 0.59 | 2,050 | 0.5 | 570 | 1,387 |
| 30038000070 | 45.3 | C1089 | 0.71 | 4,850 | 8.4 | 4,000 | 4,400 |
| 30038000070 | | | 1.31 | 3,303 | 2.6 | 1,725 | 4,281 |
| 30038500060 | 19.5 | C1043 | 1.06 | 1,975 | 2.4 | 1,200 | 253 |
| 30038500060 | 30.5 | C1041 | 0.98 | 800 | 0.1 | 0 | 3,900 |
| 30038500060 | 34.6 | C1042 | 3.03 | 9,992 | 6.3 | 5,433 | 15,114 |
| 30038500060 | 36.5 | C1012 | 0.59 | 2,050 | 0.5 | 570 | 1,387 |
| 30038500060 | 45.0 | C1089 | 0.71 | 4,850 | 8.4 | 4,000 | 4,400 |
| 30038500060 | | | 1.2 | 2,793 | 2.6 | 1,542 | 2,715 |
| 30039000060 | 17.4 | C1043 | 1.06 | 1,975 | 2.4 | 1,200 | 253 |
| 30039000060 | 29.5 | C1041 | 0.98 | 800 | 0.1 | 0 | 3,900 |
| 30039000060 | 35.9 | C1012 | 0.59 | 2,050 | 0.5 | 570 | 1,387 |
| 30039000060 | 36.5 | C1042 | 3.03 | 9,992 | 6.3 | 5,433 | 15,114 |
| 30039000060 | 42.3 | C1089 | 0.71 | 4,850 | 8.4 | 4,000 | 4,400 |
| 30039000060 | | | 1.14 | 2,534 | 2.5 | 1,424 | 2,115 |
| Total | | | 1.22 | 2,877 | 2.5 | 1,564 | 3,037 |

The last row of the previous table represents the arithmetical mean of the P_R, <Au>, <Ag>, <Cu> and <As> values in the three vertices of this triangle, which together with the are of the triangle will complete all the information needed for this triangle when generating the reports with the calculations and for its three-dimensional graphical representation.

Thus for example, separating in the database BDT2 the calculation units (triangles) with an <Au> grade over 4000 and grouping by categories, according to the nearest intersection, the following data table is obtained:

| Type | Tons | P_R | <Au> | <Ag> | <Cu> | <As> |
|---|---|---|---|---|---|---|
| 1 | 18168.00 | 1.22 | 8991.46 | 10.27 | 8292.79 | 8278.24 |
| 2 | 18758.00 | 0.99 | 7769.65 | 8.18 | 7108.28 | 9034.97 |
| 3 | 13152.00 | 1.38 | 7504.29 | 4.54 | 4219.00 | 12319.37 |
| 4 | 6940.00 | 1.40 | 7721.18 | 6.02 | 5625.34 | 9479.52 |
| Total | 57017.00 | 1.18 | 8091.86 | 7.74 | 6638.76 | 9605.54 |

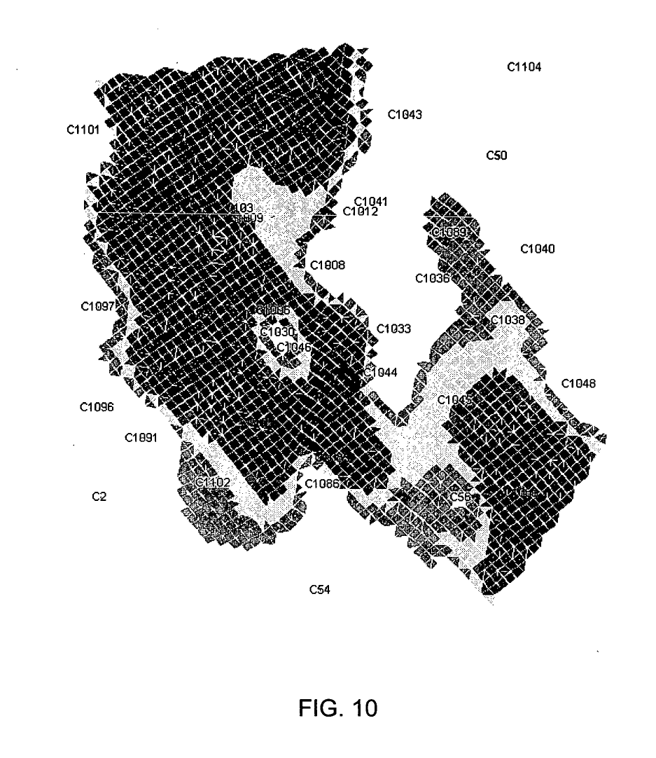

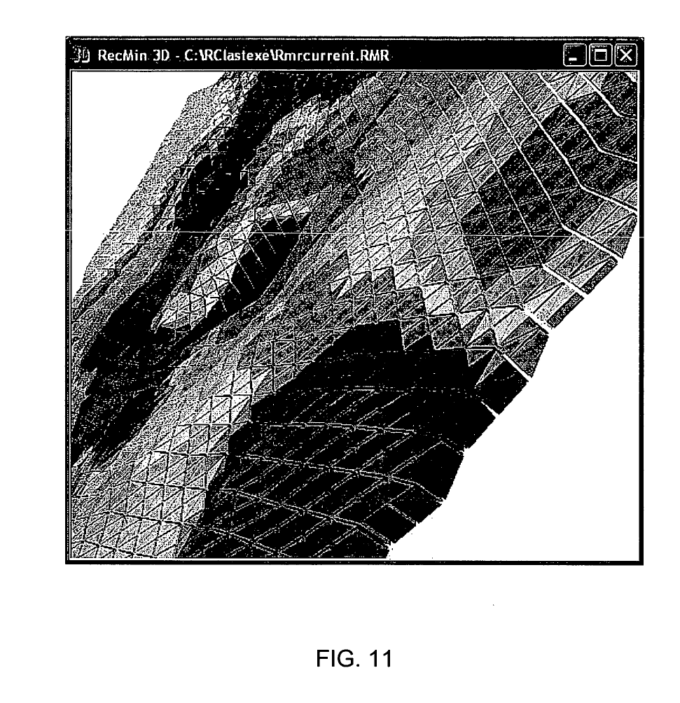

FIG. 10 shows the triangles of the above table according to the <Au> grade. Finally, FIG. 11 shows a three-dimensional view of the calculation units generated with a 3D viewer. For the sake of a better three-dimensional representation the units have been slightly separated.

1. Method for determining physico-chemical properties of a three-dimensional body, said method comprising the following steps:
a) generating a first database (BDS) that contains first data on bores intersecting said three-dimensional body, said first data defining the location and physico-chemical properties of the three-dimensional body at said bores,
b) defining a first surface (T1) in aspatial centre of the three-dimensional body by triangulation, so that said first surface (T1) extends along two main directions of said three-dimensional body,
c) defining on said first surface (T1) a cluster of points (NPS) generated with regular spacings in said two main directions of the three-dimensional body,
d) generating, by creating linked triangles between the points of said cluster of points (NPS), a second surface (T2) constituted by said triangles,
e) calculating, by an interpolation method and based on said first data in the first database (BDS), second data defining calculated physico-chemical properties of the three-dimensonal body at said points of said cluster of points (NPS),
f) generating a second database (BDT2) using the triangles constituting said second surface (T2), so that said second database contains, for each triangle constituting said second surface (T2), the coordinates of the vertices of the triangle, the second data defining calculated physico-chemical properties of the three-dimensional body at said vertices of the triangle, and the area of the triangle in space,
g) generating reports with information from the second database (BDT2), and
h) generating three-dimensional graphical representations based on the second database (BDT2).

2. Method according to claim 1, wherein the first database (BDS) comprises the following data:
data on coordinates defining the position of the intersection of each bore (s1, s2) with the three-dimensional body, wherein the coordinates can either define a single point determining the centre of the body at said bore or an interval determining the beginning and the end of the three-dimensional body at said bore, and
the data on physico-chemical properties of the three-dimensional body (data 1, data at each bore.

3. Method according to claim 1, wherein the first surface (T1) is generated by applying the triangulation method based on the coordinates of the centres of the bores, and, optionally, further based on three-dimensional interpretation of known data of this body and previous knowledge of a usual shape of the corresponding type of body.

4. Method according to claim 1, wherein the cluster of points (NPS) is generated by an algorithm based on regular spacings on the surface.

5. Method according to claim 1, wherein in step d), a triangulation algorithm based on the cluster of points (NPS) is used to generate the second surface (T2).

6. Method according to claim 1, wherein, in step e), the second data for each point of said cluster of points (NBS) are calculated based on the first data corresponding to surrounding bores.

7. Method according to claim 6, wherein for calculating said second data for any point of said cluster of points (NBS), an interpolation method is used by which the second data for said point are set to be equal to the corresponding first data corresponding to the nearest bore.

8. Method according to claim 6, wherein for calculating said second data, for any point of said cluster of points (NBS), said second data for said point are set to be the arithmetical mean of corresponding first data corresponding to bores within a maximum distance, weighted by a power of the inverse of the distance between said point and the respective bore.

9. Method according to claim 6, wherein for calculating said second data, for any point of said cluster of points (NBS), a geostatistical method, such as Kriging, is used.

10. Method according to claim 1, wherein the graphical representation generated in stage h) from the second database (BDT2) is performed by graphical software that allows the three-dimensional representation of the shape and properties of the three-dimensional body.

11. Method according to claim 1, said method being a method for determining the mineral resources or reserves of a mineral body or layer, wherein the first database (BDS) is made to contain data on the intersections of the bores with said mineral body or layer, this database comprising:
data of coordinates defining the intersection of each bore (s1, s2) with the mineral body or layer, wherein the coordinates can either define a single point determining the centre of the body at said bore, or an interval determining the beginning and the end of the three-dimensional body at said bore, and
data on the physico-chemical properties of the mineral body or layer (data 1, data 2) at each bore (s1, s2).

12. Method according to claim 11, wherein in step b), defining the first surface (T1) is made by forming linked triangles between the median points of the intersection of each bore (s1, s2) with the mineral body or layer, by using the centres of the intersections of the bores with the mineral layer, the information on any outcrops of the layer and geological interpretation regarding the spatial location of the layer, whereby a set of points and lines are defined located on a central surface of the mineral body or layer, and using these points and lines, so as to form a surface by triangulation, providing a set of linked triangles in the space, whereby sufficient points and lines are added so that the surface generated by triangulation is a faithful
representation of the centre of the mineral layer or body and covers the entire area to be studied.

13. Method according to claim 11, wherein the cluster of points (NPS) is generated applying the following steps:
an algorithm is used to fill in the first surface (T1) with points that are more or less equidistant to one another,
the distance between the points is defined according to a calculation detail required so that its final three-dimensional representation agrees with an initial interpretation of the layer,
whereby, depending on the algorithm used, the real distance between the points is not necessarily always the same.
